(19) United States
(12) Patent Application Publication
(10) Pub. No.: US 2008/0260925 A1
(43) Pub. Date: Oct. 23, 2008

(54) Means for replacing common sugars if foods for enhanced nutrition

(76) Inventor: Galen Paul Zink, Olympia, WA (US)

Correspondence Address: MARK S. HUBERT P.C., 516 SE MORRISON- SUITE 1200, PORTLAND, OR, 97214, US

(21) Appl. No.: 12/148,963

(22) Filed: Apr. 23, 2008

Related U.S. Application Data
(60) Provisional application No. 60/926,045, filed on Apr. 23, 2007.

(51) Int. Cl. A23L 1/236

(52) U.S. Cl. 426/548

(57) ABSTRACT

A means for replacing common sugars (particularly sucrose) in a range of foods that maximizes sugar-like taste, texture and other key properties of sugar while minimizing the undesirable traits such as blood sugar response, digestive side effects, high caloric content and aftertastes. Various differing ratios and combinations of high intensity sweetening agents, high molecular weight bulking agent(s), substantially non-digestible sugar(s), and low molecular weight sugar alcohol(s) are used for various applications such as tabletop sugar substitute, frozen deserts, condiments, baked goods, chocolate and confectionaries have different formulations. These sugar replacement approaches are highly relevant to the production of diabetic-friendly foods, diet and/or reduced calorie foods, non-cariogenic (tooth-friendly) foods and other sweet, low-glycemic foods.

The entire disclosure of U.S. Provisional Application No. 60/926,045, filed Apr. 23, 2007 the benefit of which is claimed, is considered to be a part of the disclosure of the accompanying application and is hereby incorporated by reference.

### BACKGROUND OF THE INVENTION

The present invention relates to a means for replacing common sugars (particularly sucrose) in a range of foods while maximizing sugar-like taste, texture and other key properties of sugar. Simultaneously, this approach enables the minimization of undesirable traits such as blood sugar response, digestive side effects, high caloric content and aftertastes. This is innovation is highly relevant to the production of diabetic-friendly foods, diet and/or reduced calorie foods, non-cariogenic (tooth-friendly) foods (particularly candies and gums) and other sweet, low-glycemic foods.

Current sugar-free foods offer few good options to their consumer. Foods based on one or more high-intensity sweetener(s) (for example, sucralose, first sold under the brand name Splenda®) do not suffer from nutritional (blood sugar, calories) or digestive problems because high intensity sweeteners are extraordinarily sweet (tens to thousands of times sweeter than sucrose by weight) and only trivial quantities are required, but they do not offer any bulk or functionality, key traits required in many applications where one may wish to replace common sugars. The most prevalent example of a food almost universally produced using high-intensity sweetener(s) only is diet soda. Diet soda is well known among consumers; it is generally regarded to be sweet but far from identical to regular soda in the minds of most who taste it.

Approaches to sweetening involving primarily (as a weight percentage of the common sugar being replaced) sugar alcohols are extremely prevalent in applications requiring the volume of sugar, such as sugar free chocolate and sugar free cookies. Sugar alcohols are structurally somewhat similar to common sugars, but have certain specific differences and are hence given a distinct name by organic chemists. These differences mean they tend to be metabolized somewhat differently and lack the browning/caramelizing properties of common sugars. Current commercially available sugar alcohols provide a range of sweetness, up to the sweetness level of sucrose, although typically they are less sweet than sucrose. To compensate for this difference, it is common to see sugar alcohol(s) paired with a low level of high intensity sweetener(s). From a sensory standpoint, many such products can be fairly good when compared to the traditional product sweetened with common sugar(s).

Unfortunately, when used in quantity as required for applications where they replace the bulk of common sugars, sugar alcohols are ridden with digestive and/or nutritional problems. The nutritional advantages of sugar alcohols rely on the substance being poorly metabolized. Unfortunately, if not metabolized, most sugar alcohols will remain in the digestive tract and cause gastric distress (diarrhea, gas, bloating.) Conversely, if metabolized, blood sugar will rise and hence contribute a substantial number of calories, providing little or no benefit versus common sugars while increasing the cost of the food and often decreasing the quality.

From the perspective of the consumer, neither gastric distress nor elevated blood sugar is particularly acceptable. Glycemic index data suggests that some sugar-free products offer no blood sugar advantage over their sucrose-sweetened equivalents. Unfortunately, diabetics are frequently unaware of this and may assume that “sugar free” means zero or substantially reduced blood sugar impact, which can be simply wrong in many cases. This can lead to potentially very harmful blood sugar situations.

A very limited range of other sugar replacement approaches have been attempted which do not rely exclusively on sugar alcohols and/or high intensity sweeteners to replace common sugars, but all attempts have met with limited market success, or, quite often, substantial failure. The most common reason for such failures is the lack of acceptable taste. Consumers are presented with a very wide range of products on a regular basis and simply prefer the products that taste the best, all other perceptible factors being similar.

Despite the numerous problems with current sugar replacement approaches, the market is clearly demanding such products. In 2006, the U.S. market for current sugar-free products at the retail level is estimated at $7.7 billion dollars. Many product categories within this market, particularly those that depend on the mass of sugar, are projected to grow at greater than the rate of inflation in coming years by major market research firms. The excessive number of calories present in the American diet, with many of them coming from common sugars, combined with the increasing awareness of common sugars as a substantial contributor to many growing chronic disease problems, supports these projections.

The strong and growing demand for sugar replacement and the inability of the market to deliver products that combine both strong nutrition and great taste has created a substantial gap in the marketplace. Despite the formidable size of this market, the lack of highly acceptable products has likely depressed the sales potential of the sugar-free market by a substantial amount.

### SUMMARY OF THE INVENTION

The present invention relates to the replacement of common sugars in food products while maintaining many sugar-like functional traits without relying primarily on sugar alcohols. In comparison to traditional approaches based on sugar alcohols and/or high intensity sweeteners and depending on the exact embodiment, it can offer improved taste, superior digestive tolerance, nutritional enhancement, improved functional properties, or any combination thereof.

The general purpose of the present invention, which will be described subsequently in greater detail, is to provide a food sweetener that is able to mimic the taste of sugar, enhance nutritional properties, and yield finished products/a finished form with as little modifications to the organoleptic profile as possible.

It has many of the advantages mentioned heretofore and many novel features that result in a new sweetener which is not anticipated, rendered obvious, suggested, or even implied by any of the prior art, either alone or in any combination thereof.

In accordance with the invention, an object of the present invention is to provide an improved food sweetener (or sugar substitute) capable of maintaining many sugar-like functional traits while providing a minimal blood sugar response.

It is another object of this invention to provide an improved food sweetener with improved taste, superior digestive tolerance.

It is a further object of this invention to provide a food sweetener with superior digestive tolerance.

It is still a further object of this invention to provide for a food sweetener with nutritional enhancement.

It is yet a further object of this invention to provide a food sweetener with improved functional properties.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### DETAILED DESCRIPTION

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

### BRIEF DESCRIPTION OF THE DRAWINGS

This application has no drawings. Pursuant to MPEP 608.02 and 35 U.S.C. 113, drawings are required where necessary for the understanding of the subject matter to be patented. Such is not the case herein. The specification does not admit of illustration by a drawing nor does the specification lack an enabling disclosure without any drawings. Further, no drawings are necessary for the purpose of interpretation of the scope of any claim. The tables therein suffice to enable and adequately explain the subject mater of the patent application.

### DETAILED DESCRIPTION

The following is intended to allow the reader a clear understanding of the elements involved as well as clarify the groupings and examples of each of the elements used herein.

### ETP

Eating temperature and pressure, designed to approximate Earth conditions at body temperature. Defined as 100 kPa of atmospheric pressure, typical Earth atmospheric gas composition and 37° C.

### Substance

A specific molecule usually referred to by a short chemical name in the context of this patent. Example: erythritol. May refer to many of the same molecules in aggregate form with no impurities. Chirality is assumed only if prefixed with D- or L-.

### Ingredient

A substance in the form as would be used in a food product. Some ingredients (e.g. erythritol FCC) approach 100% purity in ingredient form. Other ingredients (e.g. polydextrose FCC) consist of a range of different molecules (e.g. varying chain length polymers) but are still considered to be a single ingredient.

### Common Sugar(s)

Chemical definition: Ingredient consisting of one or more substances considered to be monosaccharide(s) and/or disaccharide(s) and/or oligosaccharide(s) in the context of organic chemistry.
Functional role: Provides sweetness and/or volume and/or flavor enhancing properties to the foods in which it is found. May be added to foods in pure or semi-pure form, or may occur naturally in foods.
Organoleptic properties: Sweet taste.
Nutrition: Accepted to contain approximately 4 kcal/g, the majority of which is not normally absorbed via short chain fatty acids.
Chirality: D-forms only.
Examples: D-sucrose, D-glucose, D-fructose, D-lactose, D-galactose, D-maltose, D-trehalose.

### HMWBA (High Molecular Weight Bulking Agent)

Physical properties: An ingredient able to form a non-precipitating, non-crystallizing aqueous solution of at least 20% (w/w) at ETP wherein a 20% (w/w) solution has a viscosity not in excess of 2 cP as measured 60 seconds following dissolution at ETP. Meets generally accepted chemical definitions for polysaccharides and/or oligosaccharides. Average molecular weight greater than that of sucrose.
Organoleptic properties: Neutral to sweet and/or creamy in taste. Minimal bitter, sour, salty and umami tastes. Digestion: A maximum of 40% of the dry weight of the ingredient may be absorbed into the bloodstream as glucose or fructose through the course of typical human digestion. Examples: polydextrose, fructo-oligosacchrides, oligofructose, inulin, isomalto-oligosaccharides, mannan-oligosaccharides, galacto-oligosaccharides, xylo-oligosaccharides and resistant maltodextrin.

### LMWSA (Low Molecular Weight Sugar Alcohol)

Physical properties: An ingredient able to form a stable aqueous solution of at least 10% (w/w) at ETP wherein a 10% solution has a viscosity not in excess of 2 cP as measured 60 seconds following dissolution at ETP. Average molecular weight is not to exceed 200 AMU. Organoleptic properties: Neutral to sweet and/or creamy in taste. Minimal bitter, sour, salty and umami tastes. Examples: Erythritol, mannitol.

### SNDS (Substantially Non-Digestible Sugar)

Physical properties: An ingredient able to form a stable aqueous solution of at least 10% (w/w) at ETP wherein a 10% solution has a viscosity not in excess of 2 cP as measured 60 seconds following dissolution at ETP. Organoleptic properties: Neutral to sweet and/or creamy in taste. Minimal bitter, sour, salty and umami tastes. Digestion: A maximum of 20% of the dry weight of the ingredient may be absorbed into the bloodstream as glucose or fructose through the course of typical human digestion. Examples: Tagatose, d-psicose, and 1-sucrose.

### HISA (High Intensity Sweetening Agent)

Physical properties: No specific parameters. Organoleptic properties: Sweet in taste, relative sweetness greater than that of fructose although sweetness profile (including onset and duration) may differ significantly. May be bitter. May have moderate sour, salty and/or umami tastes.
Examples: Sucralose (trichlorogalactosucrose); acesulfame potassium; saccharin and salts thereof; cyclamate and salts thereof; aspartame; neotame; alitame; Stevia plant, extracts and synthesized versions thereof; steviol salts and glycoside derivatives thereof; glycyrrhizin (carbenoxolone) and salts thereof; stevioside(s); rebaudioside(s); neohesperidin dihydrochalcone; pentadin; curculin; brazzein; thaumatin; monellin; sucrooctate; carrelame; sucrononate; lugduname; Lo Han (Siraitia grosvenorii) plant, extracts and synthesized versions thereof; Chinese Blackberry (Rubus suavissimus) plant, extracts and synthesized versions thereof; miraculin; 5-nitro-2 propoxyaniline; rubsosides; Jiaogulan (Gynostemma pentaphyllum) plant, extracts and synthesized versions thereof; perillartin (oxime derivative of perillaldehyde.)

Effective sugar replacement represents a very substantial challenge. Essentially, one strives to replicate the taste, functionality and volume of the common sugar being replacing, most frequently sucrose. Effective sugar replacement hinges on creating a product that is minimally digestible (limiting calories, blood sugar impact) yet results in minimal gastric side effects and retains a desirable organoleptic profile. Present solutions typically use maltitol or other sugar alcohol(s), possibly in combination with a low level of a high intensity sweetener to match the sweetness of sucrose, but it suffers from a myriad of problems.

This approach works and achieves the “sugar free” label in the US, but has many serious problems. Most commonly used sugar alcohols are still digested substantially. They still contain a substantial number of calories as compared to sucrose, seriously limiting the potential for caloric reduction. (2-3 kcal/g versus 4 kcal/g.) Despite being non-cariogenic, most common sugar alcohols can be broken down during typical human digestion and consequently a non-trivial amount of glucose enters the blood stream, raising blood sugar levels. This problem is so substantial that some studies have found that “sugar free” maltitol-sweetened chocolate has the same impact on blood sugar as traditional sucrose-sweetened chocolate.

The opposite of digestion into glucose as described above is non-digestion. All sugar alcohols used in foods are low to medium in terms of molecular weight. This means they can have considerable osmotic effect—the lower the molecular weight, the greater the effect. Consequently, if the body does not absorb them, they act as an osmotic laxative like Epsom salt. One low molecular weight sugar alcohol, mannitol, has been used as both a sweetener and a child's laxative due to its sweet nature. Beyond laxative side effects, various microorganisms in the digestive tract thrive on sugar alcohols and other carbohydrates that remain unabsorbed. Although these microorganisms can contribute to gastric health, excessive activity on their part causes gas and bloating. In rare situations where sensitive individuals have consumed extremely large quantities of sugar alcohols, these non-digestion side effects have been sufficiently severe to result in the consumer being admitted to the emergency room. Despite the extreme unpleasantness of these effects, they do not cause any significant lasting harm the consumer.

There seems be substantial person-to-person variation in both tolerance of sugar alcohols and the level of digestion that occurs. A particularly problematic corollary to the digestion/non-digestion paradigm, those who have the fewest gastric side effects from the consumption of sugar alcohols tend to be likely to have the greatest level of digestion and consequently receive the least benefit from consuming those foods. Effectively, most current sugar-free products tend to self-select consumers who receive the least benefit from consuming them.

Beyond digestive issues, sugar alcohols used alone suffer from three key problems:
1) Sweetness: Most sugar alcohols are slightly to substantially less sweet than the sucrose they typically replace, meaning that alone they cannot provide the same level of sweetness as sucrose and require additional ingredients and/or higher usage levels.
2) Functionality: All sugar alcohols lack the ability to brown and caramelize in foods, negatively impacting both taste and color in many cases. Molecular weight is also lower in many cases, and when used to directly replace sucrose, results in a harsh, slightly astringent taste.
3) Solutions: All sugar commercially available alcohols have a more strongly negative heat of solution than sucrose, varying from two to ten times greater than that of sucrose. This can be perceived as a “cooling effect” when the ingredient is dissolved. Many sugar alcohols are also less soluble in water, limiting formulation possibilities and frequently negatively impacting taste and/or texture.

The only commercially available sugar alcohol with minimal gastric side effects and virtually no blood sugar response is erythritol, which is rapidly absorbed in the small intestine and excreted by the kidneys unchanged. Consequently, erythritol has virtually zero calories and blood sugar impact. Most microorganisms cannot break it down, minimizing risk of gas/bloating. Erythritol is considered to be a LMWSA. However, when consumed in large quantities or faster than can be absorbed in the small intestine, it can exhibit a substantial laxative effect. The organoleptic and functional profile of erythritol is also rather poor, with only 60-70% the sweetness of sucrose, a harshness resulting from its low molecular weight and the most negative heat of solution of all commercially available sugar alcohols.

Sugar alcohols are present in nearly every sugar-free product beyond beverages and tabletop sweeteners. Maltitol represents the single most sucrose-like commercially available sugar alcohol, with a similar molecular weight, nearly the same sweetness and moderate cooling effect. Unfortunately, it still contains a substantial number of calories, impacts blood sugar, and frequently causes gastric distress.

The use of left-handed sugars (i.e. 1-sucrose) alone results in virtually perfect sugar replacement except for a substantial laxative side effect. Presently, production and regulatory issues represent significant barriers to commercial use of most left handed sugars. L-sucrose would be considered a SNDS.

The use of HISA(s) alone carries no significant nutritional or gastric concerns, but has poor taste and no functionality or volume, meaning it is of minimal value in replacing sugar outside of beverages.

In response to numerous approaches based off single ingredients and/or simple combinations, a substantially more holistic and adaptable method has been developed and constitutes this patent.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

This present invention focuses on combining three to four core types of dry ingredients within certain levels for very specific purposes based on the functionality each one provides. This enables the use of many common sugars to be replicated by varying the levels depending on the specific properties and processing conditions. In this method, the largest bulk of what we are replacing common sugar(s) with is typically a HMWBA. These substances provide a substantial amount of bulk with minimal drawbacks. From a digestive standpoint, the key is the high molecular weight—this largely mitigates osmotic Taxation effects. The human body also largely lacks enzymes capable of breaking down HMWBAs, meaning they cannot be absorbed as glucose, resulting in a low-to-nil blood sugar response. HMWBAs can also provide a low level of sweetness in some cases. Many HMWBAs also feature a positive heat of solution, which can be important for another aspect of this method.

The remainder of the bulk of common sugar(s) being replaced is made of LMWSA and/or SNDS. These are used to provide additional sweetness and in some cases, browning/caramelizing functionality from the SNDS.

Both LMWSA and SNDS frequently have a negative heat of solution, which can represent an organoleptic problem. From a digestive standpoint, the medium to low molecular weight of these compounds means they are subject to causing osmotic diarrhea and potentially undergoing fermentation, resulting in gas/bloating. Consequently, the lowest quantity possible of these substances should be used.

When commercially and technically viable, using a LMWSA and/or SNDS that is absorbed in the small intestine and excreted through the kidneys is preferable. This type of product has a minimal risk of gastric distress, as it does not generally accumulate intestinally in sufficient quantities as to cause osmotic diarrhea and/or gas/bloating from microbiological fermentation. However, there is always some threshold of consumption at which even the most readily absorbed low to medium weight water soluble substance will cause osmotic diarrhea. Consequently, this is why these substances must always be used in concert with a HMWBA when replacing the bulk of common sugar(s).

The mixture of HMWBA and LMWSA and/or SNDS is then mixed with multiple HISAs. The use of HISAs brings the sweetness of the entire mixture up to that of sucrose. There are well-documented studies showing sweetness synergy and in most cases, the more sweeteners used (both HISA and LMWSA/SNDS), the greater the level of synergy and reduced risk of off-tastes developing. The objective is to use the absolute lowest amount LMWSA and/or SNDS possible in the application while avoiding perceptible after-tastes, bitterness, lingering sweetness, etc. from the HISAs.

The exact type and ratio between LMWSA and/or SNDS must be dictated individually for each category of application, based on commercial/technical considerations, browning/caramelizing traits, and approximating the same heat of solution as the common sugar being replaced. Browning/caramelizing is readily ascertained through visual and/or taste analysis and to some extent can be compensated for through processing changes.

Heat of solution is the final and very important variable, as it impacts perception of taste, melting rate, etc. Ideally, the value of the common sugar being replaced is matched, but that is rarely precisely possible. Moreover, varying solubility means that heat of solution also has a temporal variable associated. Therefore, this is difficult to precisely quantify. However, it is absolutely vital that the heat of solution be balanced, preferably to match sucrose, which has a slightly negative heat of solution. An overly positive or negative heat of solution will negatively impact the food's taste.

### Embodiments

(Unless stated otherwise all percentages expressed represent a weight percentage of the sugar replacement.)

### Chocolate and Coating Applications

A first partial or whole sugar replacement for use in the preparation of chocolate or chocolate coatings having a composition of 60-95% HMWBA(s) and 5-40% LMWSA(s). Where in this embodiment of sugar replacement the LMWSA is not to exceed 10% of the chocolate or chocolate coating finished product weight.

A second partial or whole sugar replacement for use in the preparation of chocolate or chocolate coatings having a composition of 40-90% HMWBA(s) and 10-60% SNDS(s). Where the SNDS in this embodiment of sugar replacement is not to exceed 15% of the chocolate or chocolate coating finished product weight. SNDS usage levels are limited to more than 15% of the finished product mass, to reduce the risk of gastric/laxative side effects.

A third partial or whole sugar replacement for use in the preparation of chocolate or chocolate coatings having a composition of 10-90% HMWBA(s) and 5-60% SNDS(s)(not to exceed 20% of the chocolate or chocolate coating finished product weight) 5-40% LMWSA(s)(not to exceed 10% of the chocolate or chocolate coating finished product weigh).

Each of the above mentioned embodiments may be additionally refined if a portion of the ingredients in the sugar replacement are replaced with an insoluble mineral compound based off calcium, magnesium, or phosphorus, with the insoluble mineral having a median or mean particle size under 50 microns in the finished (post-manufacturing) chocolate/compound coating product. If the insoluble mineral compound is used to displace the least sweet components of the sugar replacers (usually the HMWBA) this will increase the relative concentration of sweeter bulk sugar replacers, thus achieving a sweeter taste. Human perception of sweetness in chocolate is based on the sweetness of soluble solids present in chocolate—in a mixture of sugar replacers of varying sweetness, replacing the non-sweet soluble solids with non-soluble solids (even if non-sweet themselves) can substantially increase the intensity of perceived sweetness. Keeping the particle size low enough will prevent it from detracting from the mouthfeel of the finished chocolate product.

When sugar replacers with an unusually low pH are used, a neutralizing agent may be added to the chocolate during the refining stage to correct this. The primary advantage is cost as it is much cheaper to control pH in the chocolate processing stage than in the manufacturing of certain sugar replacers.

In the preferred embodiment, all added common sugars are replaced, using a blend of polydextrose (HMWBA), erythritol (LWMSA), tagatose (SNDS), and dicalcium phosphate dihydrate (insoluble calcium/phosphorus mineral with low mineral density) with the addition of HISAs to adjust sweetness as necessary. (Dicalcium phosphate is used primarily because of wide availability and low cost at the present. Numerous other minerals would be used as well, if not for cost reasons.) Polydextrose, erythritol, tagatose and dicalcium phosphate levels are adjusted to achieve a level of minerals that is not nutritionally harmfully while balancing the heat of solution to be slightly negative in net (but not excessively negative), similar to that of sucrose. Tagatose usage is not to exceed 15% to minimize the risk of gastric distress.

In terms of HISAs, acesulfame potassium is used with sucralose at a ratio of no more than 20 parts acesulfame potassium per 1 part of sucralose and no less than 1 parts acesulfame potassium per 1 part of sucralose. Neotame may be used at levels not to exceed 8 ppm. Thaumatin may be used at levels not to exceed 15 ppm. Monoammonium glycyrrhizinate may be used at levels not to exceed 40 ppm.

Tagatose usage level restrictions are key. It has the potential to cause severe gastric side effects in quantity, and because of that, the FDA limits usage levels to 10-15% in most confectionary products.

Other limitations with the HISAs are primarily for taste reasons. Sucralose and ace-k in aforementioned ratios are essential to achieving a good tasting chocolate. Other HISA(s) are typically more as minor sweetness adjustment agents by comparison. Although described as the preferred embodiment, it is well known in the art that broader ranges (I.E.+200 or −100% ) of the aforementioned HISA(s) levels will also produce satisfactory embodiments.

The following are examples of the use of the aforementioned embodiments in various chocolate formulations:

### Dark Chocolate

60% cocoa liquor
16% polydextrose
10% tagatose
7.5% cocoa butter
3.4% calcium carbonate
1.5% erythritol
0.8% lecithin
0.4% vanilla planifolia pod
0.3% PGPR
0.13% acesulfame potassium
0.00875% sucralose
0.0005% neotame
Total=˜100%

### White Chocolate

28.1% deodorized cocoa butter
15% calcium carbonate
14% whey protein concentrate
12.6% polydextrose
10% nonfat dry milk
10% tagatose
4.8% milkfat
4% erythritol
0.8% bleached lecithin
0.3% PGPR
0.2% vanilla planifolia pod
0.08% titanium dioxide
0.05% sodium chloride
0.04% acesulfame potassium
0.01125% sucralose
0.01% vanillin
0.005% thaumatin
0.0003% neotame
Total=˜100%

### Mild Milk Chocolate

21.8% cocoa butter
13% polydextrose
12.5% whey protein concentrate
10% cocoa liquor
10% tagatose
9.1% calcium carbonate
9% nonfat dry milk
6.9% milkfat
3% malt extract
3% erythritol
0.8% lecithin
0.3% PGPR
0.3% vanilla planifolia pod
0.2% salt
0.075% acesulfame potassium
0.05% vanillin
0.01125% sucralose
0.0067% thaumatin
0.000375% neotame
Total=˜100%

### Medium Milk Chocolate

19.3% cocoa butter
4.2% milkfat
0.8% lecithin
0.3% PGPR
4% nonfat milk
16.7% polydextrose
12.1% calcium carbonate
11% whey protein concentrate
0.07% salt
18% cocoa liquor
10% tagatose
3.2% erythritol
0.2% vanilla planifolia pod
0.11% acesulfame potassium
0.03% vanillin
0.01125% sucralose
0.0067% thaumatin
0.0005% neotame
Total=˜100%

Chocolate Preparation Directions (common to all the various aforementioned chocolate formulations:
1) Combine all ingredients except neotame and thaumatin (if present) in the manner suitable for given chocolate processing equipment.
2) Process chocolate until desired particle size/smoothness is reached.
3) Incorporate neotame and thaumatin (if present) into the chocolate immediately before cooling or tempering the chocolate as to minimize exposure to heat.
4) When sugar replacers with an unusually low pH are used, a neutralizing agent (as is well known in the industry) must be added to the chocolate during the refining stage to correct and maintain a neutral pH.

### Confectionary Applications

A first partial or whole replacement for common sugar(s) used in a confectionary (candy) type product that is a mixture of HMWBA(s) at 70-95% and LMWSA(s) at 5-30% to yield a confectionary product without caramelizing or browning properties.

A second partial or whole replacement for common sugar(s) used in a confectionary (candy) type product that is a mixture of HMWBA(s) at 70-90% and LMWSA(s) at 5-30% and SNDS consisting of 5-20% to yield a confectionary product, with or without caramelizing or browning properties.

A third partial or whole replacement for common sugar(s) used in a confectionary (candy) type product that is a mixture of HMWBA(s) at 70-95% and SNDS consisting of 5-30% to yield a confectionary product with or without caramelizing or browning properties

A fourth partial or whole replacement for common sugar(s) used in a confectionary (candy) type product that is a mixture of HMWBA(s) consisting of 70-95% and LMWSA(s) consisting of 5-30% to yield a hard, non-chewy, non-browning/caramelizing candy.

The previous four embodiments must follow the following rules:
a. When the ingredients do not approximate the sweetness of sucrose, multiple HISAs are incorporated to approximate the sweetness of a similar sucrose-based product, wherein:
i. Optionally, sucralose, neotame and acesulfame potassium are used together synergistically to enhance sweetness and reduce bitter off-tastes and lingering sweetness. Acesulfame potassium's bitterness is masked by sweetness from HMWBA(s)/LMWSA(s)/SNDS(s)/sucralose/neotame and to ensure the proper masking of bitterness, the levels of acesulfame potassium are such that it does not account for more than 25% of the total sweetness of the finished product based on the assumption that acesulfame potassium is 150 times sweeter than sucrose.
ii. Optionally, thaumatin is used to reduce perception of bitterness and/or enhance perception of creaminess.
iii. Optionally, heat-sensitive HISA(s) are added at final stage of heat processing to minimize quantities required.

The following are examples of the use of the aforementioned embodiments in various confectionary formulations:

### English Toffee

34% polydextrose
27% roasted almonds
20% salted butter
10% chocolate
7% tagatose
1% vanilla extract
0.5% lecithin
0.4% butter flavor
0.0125% sucralose
0.05% acesulfame potassium
0.00125% neotame
1) Combine all ingredients (except chocolate, neotame and almonds) and process similar to traditional english toffee.
2) Incorporate neotame into the mixture as it reaches desirable level of caramelization—do not allow neotame to be hot for any longer than necessary.
3) Pour toffee over almonds and cool into desired form.
4) Temper chocolate and use to dip and/or coat the toffee.

### Baked Good Applications

A replacement for sugar used in baked good applications (products traditionally made with flour and common sugar(s) as a substantial portion of their finished product weight and baked) having a mixture such that HMWBA(s) replace 50-100% of the sugar's weight, and LMWSA(s) and/or SNDS(s) are optionally utilized to enhance the sweetness level and profile, according to the following rules:
a. HMWBA and LMWSA do not consist entirely of inulin/oligofructose/fructo-oligosaccharides and erythritol.
b. Multiple HISAs are utilized to both synergize sweetness level while minimizing after-taste and/or off-tastes.
c. Optionally, HMWBA(s) and/or SNDS(s) are used to enhance browning properties to be substantially similar to those of products made with common sugars.

The following are examples of the use of the aforementioned embodiments in various baked goods formulations:

### Shortbread Cookies

29.5% butter
21.2% digestion resistant starch
11.9% wheat gluten
11.4% polydextrose
4.5% egg yolk
6.4% tagatose
3.2% low water absorbtion oat fiber
2.1% butter/cream flavor
1.9% erythritol
1.1% vanilla extract
1.1% almond extract
0.4% salt
0.05% baking soda
0.016% acesulfame potassium
0.01% sucralose
0.0004% neotame
Total ˜100%
1) Warm to room temperature (˜25° C.) and emulsify butter, butter/cream flavor, egg yolk, extracts, sucralose, acesulfame potassium, neotame, tagatose and erythritol.
2) Mix remaining ingredients together in dry form until smooth and uniformly mixed.
3) Slowly incorporate dry ingredients into emulsion created in step 1.
4) Form into desired shape and bake at 300°-350° F. until done to satisfaction.

### Delicate Cake

23.2% cake flour
19.9% polydextrose
18.6% water
14.9% unsalted butter
8.7% egg white
5.3% erythritol
4.5% egg yolk
1.9% baking powder
1.3% tagatose
0.8% vanilla
0.5% butter flavor
0.2% salt
0.1% xanthan gum
0.05% cream of tartar
0.02% acesulfame potassium
0.01% sucralose
0.00083% neotame
Total ˜100%
1) Pre-mix cake flour, polydextrose, salt, xanthan gum, baking powder. Mix until homogenous and smooth.
2) All butter to warm to room temperate then cream butter, egg yolk, erythtiol, tagatose, vanilla, butter flavor, sucralose, acesulfame potassium and neotame.
3) Combine egg whites and cream of tartar and whip until soft peaks form.
4) Gradually combine dry pre-mix, creamed butter mixture and water.
5) When fully combined, fold in egg white mixture.
6) Bake at 300-350° F. until done, depending on pan size.

### Condiment Applications (Sauces, Syrups, Jams, Jellies, Fruit Preserves, Other Sweet Spreads)

A replacement for common sugar(s) as used in a condiment where HMWBA(s) account for the majority of the sugar replaced while LMWSA(s) and/or SNDS(s) are utilized to enhance sweetness and/or enhance mouthfeel. Optionally, multiple HISAs may be utilized to both synergize sweetness level while minimizing after-taste and/or off-tastes.

### Frozen Dessert Applications (Products Substantially Similar to Ice Cream, Sherbet, Sorbet or Custard)

A substitute in part or whole for the sugar used in frozen desserts to eliminate the use of glycerin and/or fructose as a freezing point depressant, that is made of a mixture of HMWBA(s) and/or LMWSA(s) and/or SNDS(s) where freezing point depression is achieved through a low level of water (approximately 60%) resulting from high solids contributed by the aforementioned substances and/or the addition of alternative low molecular weight substances consisting of LMWSA(s) and/or SNDS(s).

Optionally, multiple HISAs are utilized to both synergize sweetness level while minimizing after-taste and/or off-tastes.

### Tabletop Sugar Substitute

Tabletop sugar substitute is defined as a dry mixture that has sweetness approximately equal to or greater than sucrose by weight and/or volume with the intent of being used by the retail consumer. The tabletop sugar substitute has a sweetness ranging from twice that of sucrose to ten times that of sucrose and has a mass consisting of 0-80% HMWBA and 5-99.99% combined SNDS and LMWSA with multiple HISAs incorporated.

This range of formulations may be additionally enhanced by the addition of a hydrocolloid (such as cellulose gum, xanthan gum, guar gum, etc.) or similar readily soluble thickening agent to enhance mouthfeel in beverage applications.

A second enhancement utilizes a reduced particle size to compensate and enhance solubility when HMWBA, SNDS or LMWBA ingredients with a lower solubility profile than sucrose are used.

A third enhancement uses LMWSA or SNDS rather than HMWBA because HMWBA tends to contribute less sweetness and less sucrose-like physical properties, as it tends to be more hygroscopic and non-crystalline.

The preferred embodiment of the tabletop sweetener is formulated as follows: 98% erythritol (LMWSA), 0.68% acesulfame potassium (HISA), 0.23% sucralose (HISA), 0.017% neotame (HISA), 0.003% thaumatin (HISA), 0.05% monoammonium glycyrrhizinate (HISA), 1.065% xanthan gum. Erythritol particle size is reduced as compared to the particle size of table sugar. This achieves a mixture approximately 5 to 6 times sweeter than sucrose by weight.

The tabletop sweetener's high sweetness intensity versus sucrose makes the product more commercially viable, as most bulking agents (especially LMWSA) are much more expensive than sucrose.

It is to be noted that excessive intensity of this tabletop sweetener can be a problem. The best quality sweetness relies upon a synergy between sweetness derived from a bulk sweetener (LMWSA/SNDS/HMWBA) and sweetness from HISAs. As the percentage of sweetness climbs from the HISAs, the level of off-tastes grows. Also, an excessively intense sweetener blend is impractical from a consumer usage/packaging standpoint. For this reason the upper limit of the possible range of sweetness cannot exceed 10 times that of sucrose.

The blend of multiple HISAs achieves a much better taste profile than a single HISA. Numerous different particular ratios between them yield a good sweetness quality, and there is considerable potential for variation of ratios without dramatic taste alterations, or even elimination of some of the HISAs without dramatic taste alterations, due to overlapping sensory characteristics.

In terms of taste/nutrition/function, using a SNDS or LWMBA is both equally viable and SNDS often has slightly more sucrose-like properties. However, commercial availability (and regulatory approval) of SNDS products is currently very weak. When this changes, using a SNDS is very possible and even likely.

Having thus described the invention, what is claimed as new and desired to be secured by Letters Patent is as follows:

1. A tabletop sugar substitute comprising:
0-80 weight percent HMWBA; and
5-99.99 weight percent SNDS and LMWSA with multiple HISAs incorporated,
wherein said sugar substitute has a sweetness ranging from twice that of sucrose to ten times that of sucrose thereby enabling said sugar substitute's use as a tabletop sweetener.

2. A tabletop sugar substitute of claim 1 wherein
said LMWSA and SNDS combination constitutes 80-98 percent by weight of said substitute,
said HISA is made of a mixture of acesulfame potassium which constitutes 0-2 percent by weight of said substitute, sucralose which constitutes 0-0.8 percent by weight of said substitute, neotame which constitutes 0-0.2 percent by weight of said substitute, thaumatin which constitutes 0-0.1 percent by weight of said substitute, and monoammonium glycyrrhizinate which constitutes 0-0.1 percent by weight of the substitute, and
xanthan gum which constitutes 0-5 percent by weight of said substitute.

3. A tabletop sugar substitute of claim 1 wherein
said LMWSA is erythritol and constitutes 97-99 percent by weight of said substitute,
said HISA is made of a mixture of acesulfame potassium which constitutes 0.5-0.75 percent by weight of said substitute, sucralose which constitutes 0.15-0.35 percent by weight of said substitute, neotame which constitutes 0.005-0.040 percent by weight of said substitute, thaumatin which constitutes 0.001-0.009 percent by weight of said substitute, and monoammonium glycyrrhizinate which constitutes 0.02-0.08 percent by weight of the substitute, and
xanthan gum which constitutes 0.5-2.0 percent by weight of said substitute.

4. A partial or whole replacement of common sugars used in the preparation of chocolate or chocolate coatings comprising:
HMWBA(s)and at least one sugar substitute selected from the group of sugar substitutes consisting of LMWSA(s) and SNDS(s).

5. The sugar replacement for use in the preparation of chocolate or chocolate coatings of claim 4 further comprising:
60-95 percent by weight HMWBA(s);
5-40 percent LMWSA(s)where in said LMWSA is not to exceed 10 percent by weight of the chocolate or chocolate coating finished product weight; and
0-2 percent by weight HISA(s).

6. The sugar replacement for use in the preparation of chocolate or chocolate coatings of claim 4 further comprising:
10-90 percent by weight HMWBA(s);
5-60 percent by weight SNDS(s)not to exceed 20% of the chocolate or chocolate coating finished product weight; and
0-2 percent by weight HISA(s).

7. The sugar replacement for use in the preparation of chocolate or chocolate coatings of claim 4 further comprising:
40-90 percent by weight HMWBA(s);
10-60 percent by weight SNDS(s)not to exceed 20% of the chocolate or chocolate coating finished product weight;
5-40 percent by weight LMWSA(s)not to exceed 10% of the chocolate or chocolate coating finished product weight; and
0-2 percent by weight HISA(s).

8. The sugar replacement for use in the preparation of chocolate or chocolate coatings of claim 5 further comprising 0-30% of one or more insoluble minerals selected from the set of insoluble minerals consisting of calcium, magnesium and phosphorous.

9. The sugar replacement for use in the preparation of chocolate or chocolate coatings of claim 6 further comprising 0-30% of one or more insoluble minerals selected from the set of insoluble minerals consisting of calcium, magnesium and phosphorous.

10. The sugar replacement for use in the preparation of chocolate or chocolate coatings of claim 7 further comprising 0-30% of one or more insoluble minerals selected from the set of insoluble minerals consisting of calcium, magnesium and phosphorous.

11. The sugar replacement for use in the preparation of chocolate or chocolate coatings of claim 8 wherein one or more said HISA(s)are selected from the set of HISA(s) consisting of
sucralose; acesulfame potassium; saccharin and salts thereof; cyclamate and salts thereof; aspartame; neotame; alitame; Stevia plant, extracts and synthesized versions thereof; steviol salts and glycoside derivatives thereof; glycyrrhizin (carbenoxolone) and salts thereof; stevioside(s); rebaudioside(s); neohesperidin dihydrochalcone; pentadin; curculin; brazzein; thaumatin; monellin; sucrooctate; carrelame; sucrononate; lugduname; Lo Han (Siraitia grosvenorii) plant, extracts and synthesized versions thereof; Chinese Blackberry (Rubus suavissimus) plant, extracts and synthesized versions thereof; miraculin; 5-nitro-2 propoxyaniline; rubsosides; Jiaogulan plant, extracts and synthesized versions thereof; perillartin, and wherein the ratio of acesulfame potassium to sucralose when utilized together is between 1:1 and 20:1, and neotame levels when used are in the range 1-24 ppm, and thaumatin levels when used are in the range 1-15 ppm, and monoammonium glycyrrhizinate levels when used are in the range 1-120 ppm.

12. The sugar replacement for use in the preparation of chocolate or chocolate coatings of claim 9 wherein one or more said HISA(s)are selected from the set of HISA(s) consisting of
sucralose; acesulfame potassium; saccharin and salts thereof; cyclamate and salts thereof; aspartame; neotame; alitame; Stevia plant, extracts and synthesized versions thereof; steviol salts and glycoside derivatives thereof; glycyrrhizin (carbenoxolone) and salts thereof; stevioside(s); rebaudioside(s); neohesperidin dihydrochalcone; pentadin; curculin; brazzein; thaumatin; monellin; sucrooctate; carrelame; sucrononate; lugduname; Lo Han (Siraitia grosvenorii) plant, extracts and synthesized versions thereof; Chinese Blackberry (Rubus suavissimus) plant, extracts and synthesized versions thereof; miraculin; 5-nitro-2 propoxyaniline; rubsosides; Jiaogulan plant, extracts and synthesized versions thereof; perillartin, and wherein the ratio of acesulfame potassium to sucralose when utilized together is between 1:1 and 20:1, and neotame levels when used are in the range 1-24 ppm, and thaumatin levels when used are in the range 1-15 ppm, and monoammonium glycyrrhizinate levels when used are in the range 1-120 ppm.

13. The sugar replacement for use in the preparation of chocolate or chocolate coatings of claim 10 wherein one or more said HISA(s)are selected from the set of HISA(s) consisting of
sucralose; acesulfame potassium; saccharin and salts thereof; cyclamate and salts thereof; aspartame; neotame; alitame; Stevia plant, extracts and synthesized versions thereof; steviol salts and glycoside derivatives thereof; glycyrrhizin (carbenoxolone) and salts thereof; stevioside(s); rebaudioside(s); neohesperidin dihydrochalcone; pentadin; curculin; brazzein; thaumatin; monellin; sucrooctate; carrelame; sucrononate; lugduname; Lo Han (Siraitia grosvenorii) plant, extracts and synthesized versions thereof; Chinese Blackberry (Rubus suavissimus) plant, extracts and synthesized versions thereof; miraculin; 5-nitro-2 propoxyaniline; rubsosides; Jiaogulan plant, extracts and synthesized versions thereof; perillartin, and wherein the ratio of acesulfame potassium to sucralose when utilized together is between 1:1 and 20:1, and neotame levels when used are in the range 1-24 ppm, and thaumatin levels when used are in the range 1-15 ppm, and monoammonium glycyrrhizinate levels when used are in the range 1-120 ppm.

14. The sugar replacement for use in the preparation of chocolate or chocolate coatings of claim 11 wherein said insoluble minerals are dicalcium phosphate.

15. The sugar replacement for use in the preparation of chocolate or chocolate coatings of claim 12 wherein said insoluble minerals are dicalcium phosphate.

16. The sugar replacement for use in the preparation of chocolate or chocolate coatings of claim 13 wherein said insoluble minerals are dicalcium phosphate.

17. The sugar replacement for use in the preparation of chocolate or chocolate coatings of claim 16 further comprising:
tagatose at 8-15 percent by weight of the chocolate or chocolate coating;
LMWSA at 1-8 percent by weight of the chocolate or chocolate coating; and

18. The sugar replacement for use in the preparation of chocolate or chocolate coatings of claim 17 further comprising:
thaumatin at 0.5-15 ppm by weight of the chocolate or chocolate coating; and
monoammonium glycyrrhizinate at 0-40 ppm by weight of the chocolate or chocolate coating.

19. The sugar replacement for use in the preparation of chocolate or chocolate coatings of claim 18 wherein said HMWBA is polydextrose; and
neotame at 1-8 ppm by weight of the chocolate or chocolate coating.
